(19) United States
(12) Patent Application Publication
(10) Pub. No.: US 2022/0406299 A1
(43) Pub. Date: Dec. 22, 2022

(54) KEYWORD DETECTIONS BASED ON EVENTS GENERATED FROM AUDIO SIGNALS

(71) Applicant: Hewlett-Packard Development Company, L.P., Spring, TX (US)

(72) Inventors: Manu Rastogi, Palo Alto, CA (US); Madhu Sudan Athreya, Palo Alto, CA (US)

(73) Assignee: Hewlett-Packard Development Company, L.P., Spring, TX (US)

(21) Appl. No.: 17/641,634

(22) PCT Filed: Oct. 17, 2019
(86) PCT No.: PCT/US2019/056638

§ 371 Date: Mar. 9, 2022

(51) Int. Cl. G10L 15/16; G10L 15/06

(52) U.S. Cl. CPC G10L 15/16; G10L 15/063; G10L 2015/088

(57) ABSTRACT

In example implementations, a device is provided. The device includes a microphone, an event generator, a keyword detector, and a digital signal processor. The digital signal processor is in communication with the keyword detector. The microphone is to receive an audio signal. The event generator generates a pattern of events from the audio signal. The keyword detector detects a keyword based on the pattern of events generated by the event generator. In response to the keyword being detected, the digital signal processor is activated to analyze subsequent audio streams.

### BACKGROUND

Devices that analyze audio are used for various applications. For example, digital assistants can be used to help users with a variety of daily tasks. For example, the digital assistants can help provide information, reminders, maintain task lists, and the like. The digital assistants can operate by continuously listening for audio streams. The audio streams can be processed to wake the digital assistant and then provide the information the user is looking for.

### BRIEF DESCRIPTION OF THE DRAWINGS

FIG. 1 is a block diagram of an example device with an event based keyword detector of the present disclosure;

FIG. 2 is a block diagram of an example event based keyword detector of the present disclosure;

FIG. 3 is a block diagram of an example event generator of the present disclosure;

FIG. 4 illustrates graphs associated with the audio signal, integral of the audio signal, and generated events of the present disclosure;

FIG. 5 is a block diagram of another example event based keyword detector of the present disclosure;

FIG. 6 is a block diagram of an example event based keyword detector with a feedback loop of the present disclosure;

FIG. 7 is a flow chart of an example method for detecting a keyword based on events generated from an audio signal of the present disclosure; and

FIG. 8 is a block diagram of an example non-transitory computer readable storage medium storing instructions executed by a processor to detect a keyword based on events generated from an audio signal.

### DETAILED DESCRIPTION

Examples described herein provide devices with event based keyword detectors. As discussed above, devices with voice activated digital assistants are becoming more ubiquitous. Voice activated digital assistants can be activated by speaking a keyword to “wake” the voice activated digital assistant. However, the voice activated digital assistants are deployed on devices that use a continuous power source. For example, the device may be plugged into a power outlet to power a digital signal processor (DSP) that is continuously processing audio until a keyword is detected by the DSP.

Due to the high consumption of power to continuously operate the DSP, the voice activated digital assistants have not moved to mobile devices. The continuous operation of the DSP may consume too much power to make it practical to operate on battery operated devices (e.g., mobile devices).

Rather, on mobile devices, a user may select a button to activate the digital assistant. After the button is pressed, the user may interact with the voice activated digital assistant.

Examples herein provide a device that includes a separate component to initially analyze the audio stream using less power. Once the keyword is detected, the DSP (or any other type of deep learning/machine learning system) can be activated to analyze subsequent streams of audio. As a result, the voice activated digital assistants can be deployed on mobile devices that operate on battery power. The DSP can be selectively activated once the keyword is detected by a low power consumption component that can detect keywords based on events generated from an audio stream. Thus, the device can continuously monitor audio signals to detect the keyword without greatly affecting the battery life on the mobile devices.

In one example, the device may also provide improved privacy. For example, an event based keyword detector in the device may be tuned such that the events generated from the audio signal cannot be reconstructed into the original audio signal.

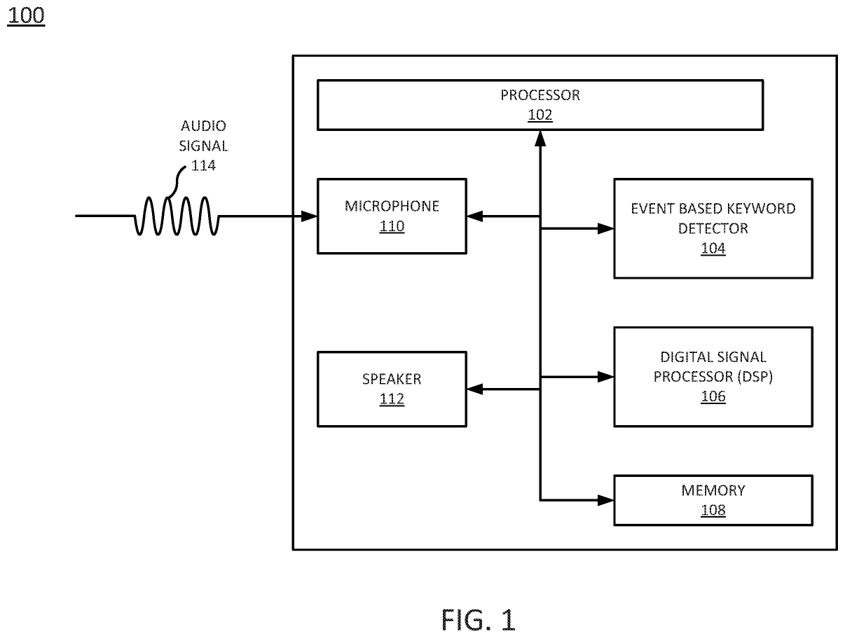

FIG. 1 illustrates an example of a device 100 with an event based keyword detector 104 of the present disclosure. The device 100 may be a stand-alone device that provides a voice activated digital assistant or the device 100 may be a computing device that includes a voice activated digital assistant. The device 100 may be powered via a power outlet or may be a mobile device that is powered by a battery.

In an example, the device 100 may include a processor 102, the event based keyword detector 104, a digital signal processor (DSP) 106, a memory 108, a microphone 110, and a speaker 112. The processor 102 may be communicatively coupled to, and control operation of, the event based keyword detector 104, the DSP 106, the memory 108, the microphone 110, and speaker 112. The DSP 106 may be any type of very long instruction word (VLIW) processor, single instruction multiple data (SIMD) processor, application specific integrated chip (ASIC), deep learning system, machine learning system, and the like.

In an example, the memory 108 may be a non-transitory computer readable medium that includes instructions executed by the processor 102. For example, the instructions to perform the functions for a voice activated digital assistant may be stored in the memory 108. The memory 108 may also store data. For example, an audio signal 114 received by the microphone 110 may be temporarily stored in the memory 108 for sampling and tuning the event based keyword detector 104, as described in further details below. The memory 108 may be a hard disk drive, random access memory, read only memory, and the like.

In an example, the event based keyword detector 104 may be deployed as dedicated hardware components within the device 100. The components may be programmed to perform a particular function. The components, in combination, may represent the event based keyword detector 104 to perform keyword detection on the audio signal 114 based on events generated from the audio signal 114.

An amount of data generated by the events may be much smaller than the amount of data generated by the audio signal 114. For example, the events may be a portion of the audio signal 114. As a result, the processing power used to analyze the lower amount of data associated with the events may consume less power than traditional analysis of the entire audio signal 114 by the DSP 106.

The event based keyword detector 104 may process the audio signal 114 to search for a keyword based on the events. The keyword may be a command or word that is spoken by a user to begin interaction with the voice activated digital assistant. In response to detecting the keyword, the event based keyword detector 104 may send an enable signal to the DSP 106. The DSP 106 may then perform full analysis on subsequent audio signals 114 that are received. For example, the subsequent audio signals 114 may by-pass the event based keyword detector 104 until the DSP 106 is deactivated again. The user may provide the audio signals 114 via the microphone 110 and the voice activated digital assistant may provide information via the speaker 112.

As a result, the large amount of power consumed by the DSP 106 to perform full analysis of the entire audio signal 114 continuously may be avoided. Rather, a lower amount of power may be consumed by the event based keyword detector 104 to analyze events generated from the audio signal 114 until a keyword is detected. In response to detecting the keyword, the DSP 106 may be activated.

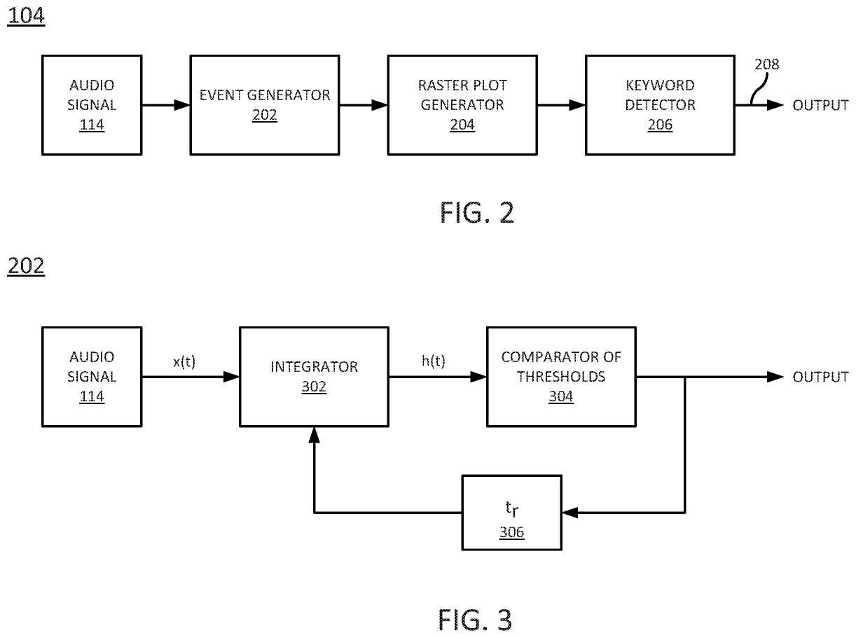

FIG. 2 illustrates an example of the event based keyword detector 104. In one example, the event based keyword detector 104 be a biphasic integrator that may include an event generator 202, a raster plot generator 204, and a keyword detector 206 to generate an output 208. The output 208 may be a signal to indicate whether the keyword is detected or not detected. In an example, the output 208 may be a confidence score related to how confident the keyword detector 206 is with respect to detecting the keyword. In one example, the event generator 202 may generate events form the audio signal 114.

In an example, the raster plot generator 204 may record the events generated by the event generator 202 as a raster plot. The raster plot may be a way that the events are recorded and stored in memory for analysis by the keyword detector 206. The raster plot may be stored as data in memory 108, accessed by the keyword detector 206, and analyzed to detect a pattern of events.

In an example, the raster plot may be represented as a two dimensional graph in a Cartesian coordinate system. An x-axis of the raster plot may represent time (e.g., in seconds). The y-axis may represent a particular event generator 202. As discussed in further details below, a plurality of the event generators 202 may be deployed.

The raster plot may provide a visual representation of the events that are generated by the event generator 202. Different words or audio signals may be represented by different patterns of events that can be detected within the raster plot.

In an example, the keyword detector 206 may be any type of component (e.g., hardware, software, or combination of hardware and software) that can be trained to detect a keyword by recognizing a pattern of events that is associated with the keyword. In an example, the keyword detector 206 may be a neural network. Examples of neural networks include a recurrent neural network (RNN) that uses a long short-term memory (LSTM) element, a convolutional neural network (CNN), a spiking neural network (SNN), and the like.

The keyword detector 206 may be trained to detect the keyword in the raster plot generated by the raster plot generator 204. In other words, the keyword may be detected by the keyword detector 206 when a pattern in the events generated by the event generator 202 matches a pattern of events associated with a known keyword. The keyword detector 206 may be trained to detect the pattern of events associated with the known keyword.

FIG. 3 illustrates an example of the event generator 202. In an example, the event generator 202 may include an integrator 302, a comparator of thresholds 304, and a reset, or refractory, timer (tᵣ) 306. The integrator 302, the comparator 304, and the reset, or refractory, timer 306 may be implemented as independent components or combined into a single component in the device 100. For example, the integrator 302, the comparator 304, and the reset, or refractory, timer 306 can be deployed as hardware that are programmed to perform the functions described herein. The integrator 302, the comparator 304, and the reset, or refractory, timer 306 can be deployed as components that include memory to store instructions that can be executed by a processor (e.g., the processor 102) or as a dedicated ASIC.

In an example, the audio signal 114 may be provided to the integrator 302 as a series of input values x(t). The audio signals x(t) may be integrated over time to generate integrated audio signal values h(t).

The comparator 304 may be set with a positive and a negative threshold value. Said another way, the threshold value may be represented as a positive value and a negative value in the comparator 304. In an example, the threshold values may be set to +0.5 and −0.5. However, it should be noted that the threshold values can be non-symmetrical (e.g., +0.8 and −0.3).

Each one of the integrated audio signal values h(t) may be compared against the positive and negative threshold values in the comparator 304. When an integrated audio signal value h(t) exceeds the threshold, the event generator may output a signal or value indicating that an event has been generated. When an event is generated, the reset, or refractory, timer 306 may pause the integrator 302 for a predefined amount of time associated with the reset timer 306 (e.g., 10 seconds, 30 seconds, and so forth). After the reset timer 306 expires, the integrator 302 may continue to integrate the audio signal x(t) to generate integrated audio signal values h(t). The comparator 304 may again compare the integrated audio signal values h(t) to the threshold until the threshold is exceeded to generate another event. The process may be continuously repeated for the audio signal 114.

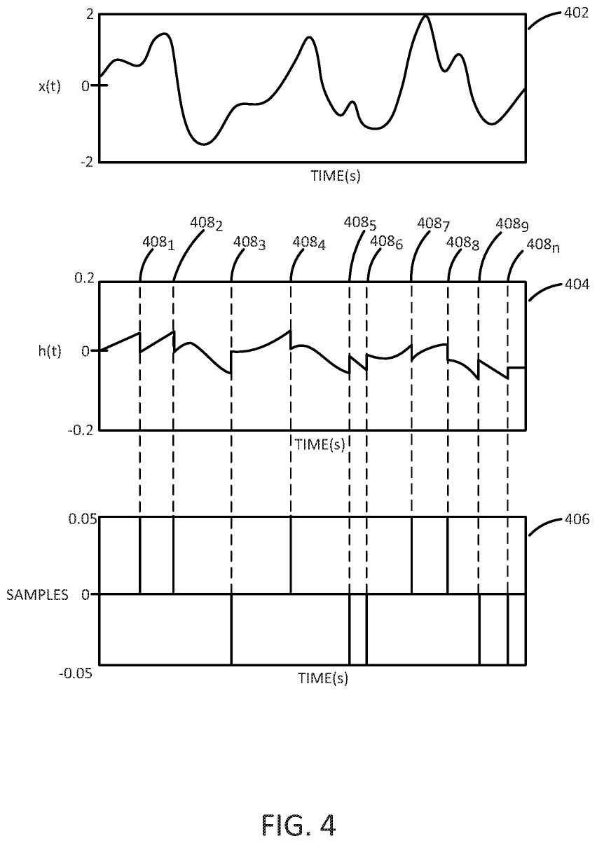

FIG. 4 illustrates graphs 402, 404, and 406 that provide a visual representation of the operation of the integrator 302, the comparator 304, and the output, or event detection, illustrated in FIG. 3. The x-axis in each of the graphs 402, 404, and 406 may represent time (e.g., seconds) and the y-axis may represent a value.

For example, the audio signal 114 may be represented as values x(t) as shown by the graph 402. The values x(t) may vary over time. The audio signal 114 may be integrated to calculate the integrated audio signal values h(t) illustrated in the graph 404.

Using the example threshold value of +0.5 and −0.5 described above, the integrated audio signal values h(t) may be compared to the threshold. At time 408₁, the value of h(t) may exceed +0.5. As a result an event may be detected as indicated by a corresponding line in the graph 406. As noted above, the reset timer 306 may pause the integrator 302 for a predefined period of time.

The integrator 302 may begin integrating the audio signal x(t) again after the reset timer 306 expires. The value of h(t) begins to rise again until the threshold value of +0.5 is exceeded again at time 408₂. As a result, a corresponding line is generated at time 408₂ in the graph 406 and a second event is generated.

The above process can be repeated for the audio signal x(t) to detect the events at times 408₁-408ₙ, as illustrated in the graph 406. The pattern of the events (e.g., the spacing between the events at times 408₁-408ₙ, the amount of events that is generated, and the like) can be recorded in a raster plot and provide a pattern. For example, the pattern of events generated at times 408₁-408ₙ in the graph 406 may be associated with a keyword and recorded in a raster plot. When the pattern is detected by the keyword detector 206, the neural network may determine that the keyword is detected.

In addition, the events may compress the amount of data consumed by the audio signal 114 by a large amount. For example, 10 events may be detected from the audio signal 114 that may have 100 points of data. Thus, the amount of data to be analyzed may be compressed or reduced by 10 times in one example. As noted above, this may reduce the amount of processing to analyze the smaller amount of data and consume less power than processing the raw audio signal or other audio processing techniques.

Based on the descriptions above, an “event” may be defined as an output of the event generator 202. Said another way, an “event” may be defined as a time when an integrated value of the audio signal exceeds a threshold value.

In an example, the amount of events that is generated may be controlled or tuned based on the value of the threshold set in the comparator 304. For example, the larger the threshold, the fewer events that may be detected. For example, in FIG. 4, it can be seen on the graph 404 that a longer time period may elapse before the integrated value of the audio signal x(t) may rise or fall enough to exceed a larger threshold. As a result, over time fewer events may be detected.

Conversely, the smaller the threshold, the more events that may be detected. For example, in FIG. 4, it can be seen on the graph 404 that a shorter time period may elapse before the integrated value of the audio signal x(t) may rise or fall enough to exceed a smaller threshold. As a result, over time more events may be detected.

The value of the threshold in the comparator 304 may be set to optimize the event generator 202. For example, as the threshold value is reduced, the number of events approaches the same number of data points as originally found in the audio signal x(t). As a result, the savings in power and processing resources may be reduced as the amount of data increases. However, as the threshold value is increased, the number of events is reduced to a point where the confidence and accuracy of the keyword detection performed by the keyword detector 206 may be reduced. In addition, as the threshold value is increased and the number of events is reduced, privacy is increased as the audio signal 114 cannot be reconstructed from the events that are generated. Thus, the threshold value in the comparator 304 may be set to generate a number of events that minimizes the processing resources to analyze the data (e.g., reduces power consumption), maximizes the accuracy and confidence of the keyword detector 206 to detect the keyword, and provides privacy such that the audio signal cannot be reconstructed from the events that are generated.

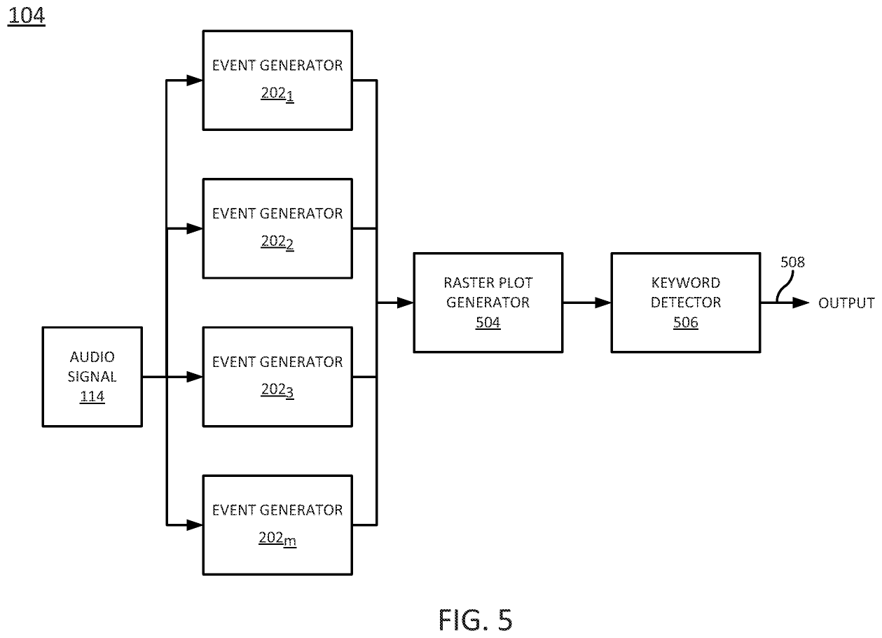

FIG. 5 illustrates a block diagram of another example of the event based keyword detector 104. In one example, the event based keyword detector 104 may include a plurality of event generators 202₁ to 202ₘ. Each one of the event generators 202₁ to 202ₘ may be deployed as shown by the event generator 202 illustrated in FIG. 3, and discussed above. The event based keyword detector 104 illustrated in FIG. 5 may also include a raster plot generator 504, and a keyword detector 506 to generate an output 508. In an example, the output 508 may be a signal to indicate whether the keyword is detected or not detected. In an example, the output 508 may be a confidence score related to how confident the keyword detector 506 is with respect to detecting the keyword.

In one example, the event generators 202₁ to 202ₘ may each be set with a different threshold value. For example, the comparator 304 of the event generator 202₁ may be set to a first threshold value. The comparator 304 of the event generator 202₂ may be set to a second threshold value. The comparator 304 of the event generator 202₃ may be set to a third threshold value, and so forth.

As a result, each one of the event generators 202₁ to 202ₘ may generate a different number of events. As discussed above, the threshold value of the comparator 304 may determine how many events are generated by a respective event generator 202₁ to 202ₘ. The raster plot generator 504 may generate a raster plot that includes each event generator 202₁ to 202ₘ along the y-axis and time along the x-axis. The events generated by each event generator 202₁ to 202ₘ may be recorded in the raster plot. The raster plot may then be provided to the keyword detector 506.

In an example, the keyword detector 506 may be trained to detect a pattern of events from the event generators 202₁ to 202ₘ recorded in the raster plot that represents a keyword. For example, the keyword detector 506 may be trained to detect a particular pattern of events from the event generators 202₁ to 202ₘ that is associated with a known keyword. When the pattern of events in the raster plot matches the pattern of events associated with the known keyword, the keyword detector 506 may determine that the keyword is detected. The keyword detector 506 may be a neural network, such as an RNN that uses an LSTM element, a CNN, an SNN, and the like.

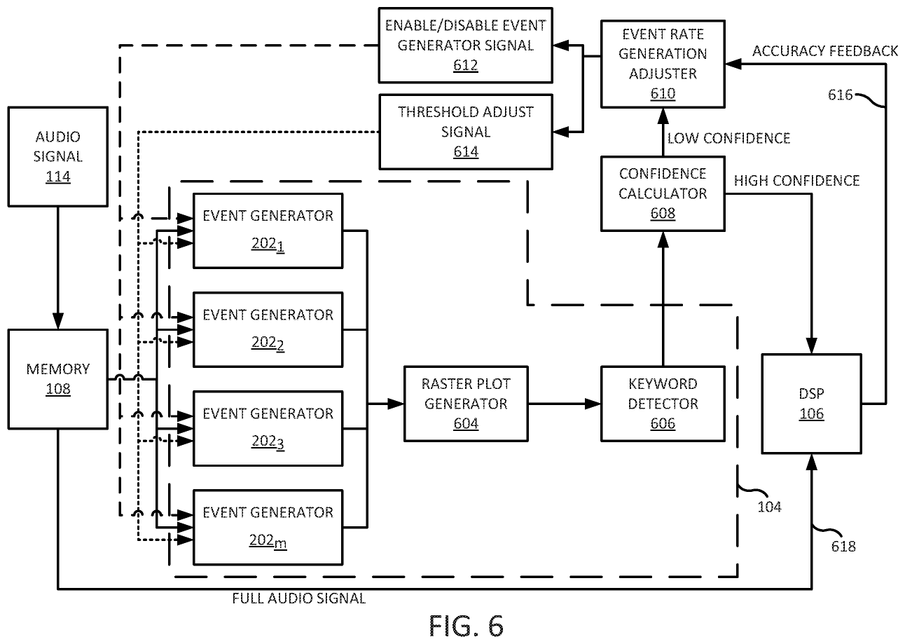

In an example, the event generators 202₁ to 202ₘ may each be selectively enabled or disabled. For example, a different combination of event generators 202₁ to 202ₘ and associated number of events generated by the event generators 202₁ to 202ₘ may provide the most accurate and confident keyword detection. The event generators 202₁ to 202ₘ may be tuned before being implemented in the device 100 via a feedback loop, as illustrated in FIG. 6.

In an example, the event generators 202₁ to 202ₘ may operate in a cascading fashion to trigger the DSP 106. For example, the first event generator 202₁ may generate events from the audio signal 114. The raster plot generator 504 may generate the raster plot of the events and the keyword detector 506 may detect a desired keyword based on detecting a pattern of events associated with the desired keyword in the raster plot.

If the desired keyword is detected from the events generated by the first event generator 202₁, the second event generator 202₂ may be executed. The second event generator 202₂ may have threshold values (e.g., in the respective comparator of thresholds 304) and generate events from the same audio signal 114 processed by the first event generator 202₁, but with tighter threshold values. The raster plot generator 504 may generate a raster plot of events and the keyword detector 506 may detect a desired keyword based on detecting a pattern of events associated with the desired keyword in the raster plot.

If the desired keyword is detected, the process may be repeated with the third event generator 202₃ and continue up to the last event generator 202ₘ. The threshold values for each successive event generator 202₃ to 202ₘ may continue to get tighter (e.g., the range becomes gradually narrower). If the desired keyword is detected based on the events generated by the last event generator 202ₘ, the keyword detector 506 may generate a signal that causes the DSP 106 to trigger and begin full analysis of subsequent audio signals.

FIG. 6 illustrates an example of an event based keyword detector 104 with a feedback loop. In an example, event based keyword detector 104 may include a plurality of event generators 202₁ to 202ₘ, a raster plot generator 604, and a keyword detector 606. The event generators 202₁ to 202ₘ may be deployed similar to the event generator 202 illustrated in FIG. 3, and discussed above. The keyword detector 606 may be a neural network, such as an RNN that uses an LSTM element, a CNN, an SNN, and the like.

In an example, the feedback loop may include the memory 108, the DSP 106, a confidence calculator 608, and an event rate generation adjuster 610. The feedback loop may be used to tune the event generators 202₁ to 202ₘ such that the keyword detector 606 may consistently detect the keyword with accuracy and confidence. The event generators 202₁ to 202ₘ may be tuned by adjusting the threshold values in the respective comparators 304 of the event generators 202₁ to 202ₘ and/or selectively enabling or disabling the event generators 202₁ to 202ₘ.

The event based keyword detector 104 may operate similar to the event based keyword detector 104 illustrated in FIG. 5 and discussed above. The keyword detector 606 may output a confidence score indicating how confident the keyword detector 606 is regarding keyword detection in the patterns found in the raster plot of events generated by the event generators 202₁ to 202ₘ. The confidence calculator 608 may compare the confidence score from the keyword detector 606 to a confidence threshold value. For example, the confidence threshold value may be 80%, 90%, 99%, and the like. When the confidence value output by the keyword detector 606 exceeds the confidence threshold value, the confidence calculator 608 may output a high confidence signal to the DSP 106.

In one example, the high confidence signal may be an enable signal to the DSP 106 to begin operating and performing full analysis on subsequent audio streams. For example, the subsequent audio signals may be provided directly to the DSP 106 rather than being fed through the event based keyword detector 104 when the DSP 106 is activated.

In one example, when the event generators 202₁ to 202ₘ are being tuned, the DSP 106 may verify whether or not the keyword detector 606 was accurate in detecting the keyword. For example, it is possible that the neural network may provide high confidence in an inaccurate conclusion.

The audio signal 114 may be temporarily stored in the memory 108 to be sampled by the DSP 106. The DSP 106 may analyze the audio signal 114 to determine if the keyword is detected. If the keyword is detected in the audio signal 114 by the DSP 106, then the DSP 106 may provide feedback that the keyword was accurately detected by the keyword detector 606. If the keyword is not detected in the audio signal 114 by the DSP 106, then the DSP 106 may provide feedback that the keyword was not accurately detected. The DSP 106 may provide an accuracy feedback 616 to the event rate generation adjuster 610.

In an example, if the confidence calculator 608 determines that the confidence value generated by the keyword detector 606 is below the confidence threshold value, then a low confidence signal may be transmitted to the event rate generation adjuster 610. In response to a signal from the DSP 106 that the keyword detector 606 was inaccurate, in response to a low confidence signal from the confidence calculator 608, or in response to both, the event rate generation adjuster 610 may tune the event generators 202₁ to 202ₘ.

In an example, the event rate generation adjuster 610 may generate an enable/disable event generator signal 612 and/or generate a threshold adjust signal 614. The enable/disable event generator signal 612 may send either an enable signal or a disable signal to any one of the event generators 202₁ to 202ₘ. The threshold adjust signal 614 may set the threshold value in the respective comparators 304 of the event generators 202₁ to 202ₘ to a desired value. In one example, the threshold adjust signal 614 may cause the threshold value to be incrementally increased or decreased.

After the event rate generation adjuster 610 tunes the event generators 202₁ to 202ₘ, the process may be repeated with another audio signal 114. The process may be repeated until the keyword detector 606 generates a confidence score that exceeds the confidence threshold and the DSP 106 indicates that the keyword detector 606 has accurately detected the keyword.

In an example, the event rate generation adjuster 610 may perform step changes to perform the tuning. For example, the event generators 202₁ to 202ₘ may all be initially enabled and have the respective comparators 304 set to a particular threshold value. For example, the threshold value may be different for respective comparator 304 of each event generator 202₁ to 202ₘ. The event rate generation adjuster 610 may disable one event generator 202₁ to 202ₘ at a time for each iteration of the feedback and tuning loop that is performed. The event rate generation adjuster 610 may then incrementally change the threshold value in the respective comparators 304 of the event generators 202₁ to 202ₘ one at a time. For example, the event rate generation adjuster 610 may increase or decrease the threshold value of the event generator 202₁ by 0.05, then increase or decrease the threshold value of the event generator 202₂ by 0.05, and so forth.

In an example, the event rate generation adjuster 610 may perform changes randomly. For example, the event rate generation adjuster 610 may disable the event generator 202₂ and change the threshold value of the comparator 304 of the event generator 202₃. If another tuning step is performed, the event rate generation adjuster 610 may enable the event generator 202₂ and change the threshold value of the comparator 304 in the event generator 202₁ and the threshold value of the comparator 304 in the event generator 202₂, and so forth.

Thus, in an example, the event based keyword detector 104 may be tuned such that the keyword is detected in the audio signal 114 with high confidence and accuracy. Once the event based keyword detector 104 is tuned, the tuning/feedback process may be stopped and the device 100 may be activated to listen for the keyword. In an example, the tuning/feedback process may be periodically performed to ensure that the event based keyword detector 104 continues to detect the keyword in the audio signal 114 with high confidence and accuracy over time.

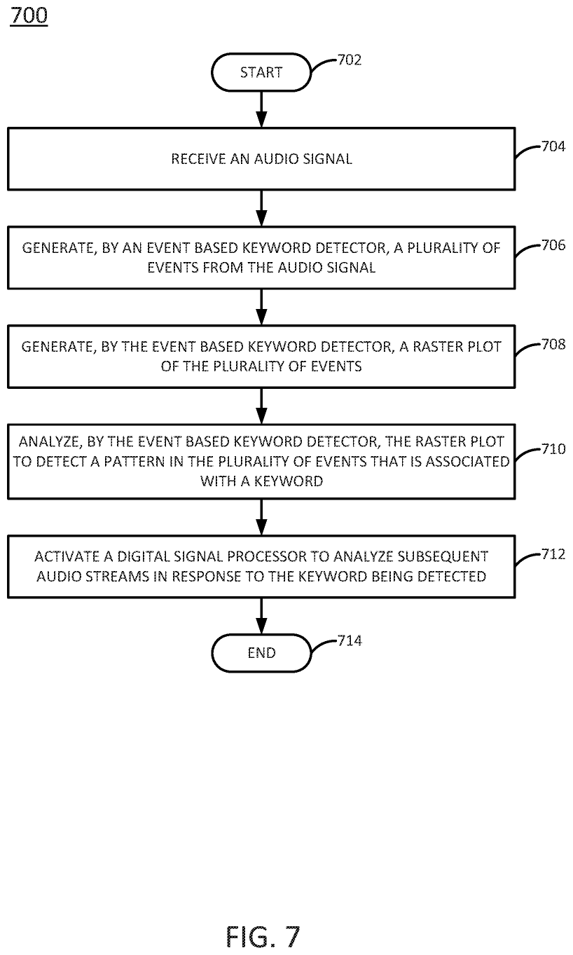

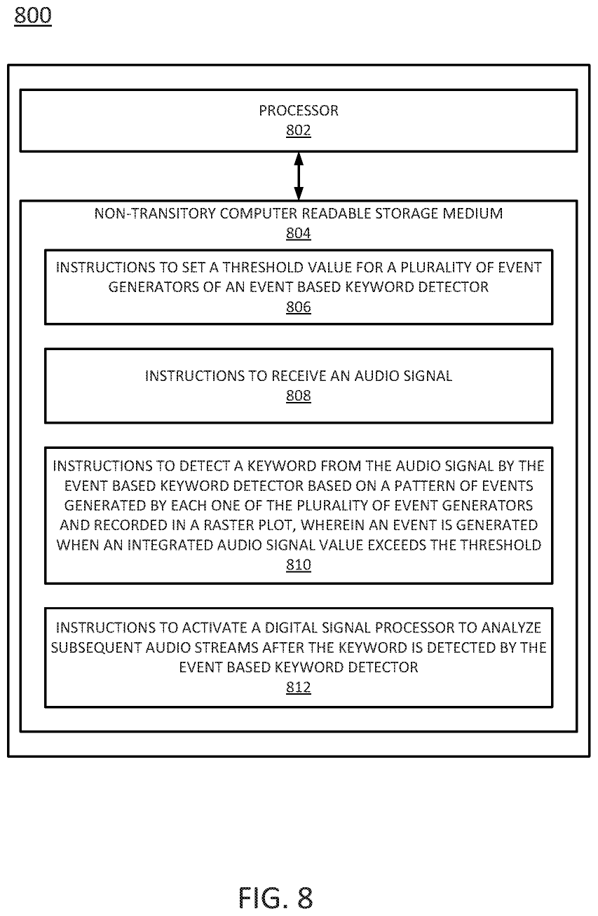

FIG. 7 illustrates a flow diagram of an example method 700 for detecting a keyword based on events generated from an audio signal. In an example, the method 700 may be performed by the device 100 or the apparatus 800 illustrated in FIG. 8, and described below.

At block 702, the method 700 begins. At block 704, the method 700 receives an audio signal. For example, the audio signal may be sound or speech received via a microphone of the device.

At block 706, the method 700 generates, by an event based keyword detector, a plurality of events from the audio signal. In an example, the event based keyword detector may include an event generator to generate events from the audio signal. The event generator may be a biphasic integrator that integrates the audio signal over time. The integrated audio signal values may be compared to a positive and a negative threshold value. When the integrated audio signal value exceeds either the positive or negative threshold value, an event may be detected. The integrator may be paused for a predefined period of time after the event is generated before continuing to integrate the audio signal over time. The process may then be repeated. Thus, the amount of data may be reduced by compressing the audio signal into a smaller number of events that represents the audio signal.

In an example, the event generators of the event based keyword detector may be tuned beforehand. The tuning may store the audio signal in memory to be sampled by a digital signal processor (DSP). The detection of the keyword by the event based keyword detector may be compared to the detection of the keyword by the digital signal processor in the audio signal. Based on the difference in detection, the event generators may be tuned. For example, the tuning may selectively enable or disable event generators and/or change a threshold value of a respective comparator of the event generators. The tuning process may be repeated until an amount of accuracy (e.g., accurate greater than 90% of the time) and an amount of confidence (e.g., a confidence score above 95%) are above a desired threshold before the audio signal is received.

At block 708, the method 700 generates, by the event based keyword detector, a raster plot of the plurality of events. For example, the event based keyword detector may include a raster plot generator. The raster plot generator may record each event generated from each event generator on a Cartesian coordinate system.

At block 710, the method 700 analyzes, by the event based keyword detector, the raster plot to detect a pattern in the plurality of events that is associated with a keyword. For example, the event based keyword detector may include a neural network that can be trained to detect a particular pattern of events in the raster plot. The particular pattern of events may be associated with a known keyword to activate a voice activated digital assistant. The neural network may detect the keyword when a pattern of events in the raster plot matches the particular pattern of events that is associated with the known keyword.

At block 712, the method 700 activates a digital signal processor to analyze subsequent audio streams in response to the keyword being detected. For example, when the keyword is detected by the event based keyword detector, an enable signal may be sent by the event based keyword detector to the digital signal processor. The digital signal processor may activate and analyze the subsequent audio streams. In other words, when the digital signal processor is activated, the subsequent audio streams may by-pass the event based keyword detector until interaction with the voice activated digital assistant is completed. In an example, the interaction may be completed when no audio signal is detected for a predefined period of time.

When the interaction ends and the voice activated digital assistant is deactivated, the digital signal processor may also be deactivated. Audio signals may then be passed through the event based keyword detector again until the keyword is detected. At block 714, the method 700 ends.

FIG. 8 illustrates an example of an apparatus 800. In an example, the apparatus 800 may be the device 100. In an example, the apparatus 800 may include a processor 802 and a non-transitory computer readable storage medium 804. The non-transitory computer readable storage medium 804 may include instructions 806, 808, 810, and 812 that, when executed by the processor 802, cause the processor 802 to perform various functions.

In an example, the instructions 806 may include instructions to set a threshold value for a plurality of event generators of an event based keyword detector. The instructions 808 may include instructions to receive an audio signal. The instructions 810 may include instructions to detect a keyword from the audio signal by the event based keyword detector based on a pattern of events generated by each one of the plurality of event generators and recorded in a raster plot, wherein an event is generated when an integrated audio signal value exceeds the threshold. The instructions 812 may include instructions to activate a digital signal processor to analyze subsequent audio streams after the keyword is detected by the event based keyword detector.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A device, comprising:
a microphone to receive an audio signal;
an event generator to generate a pattern of events from the audio signal;
a keyword detector to detect a keyword based on the pattern of events; and
a digital signal processor in communication with the keyword detector, wherein the digital signal processor is activated to analyze subsequent audio streams in response to detection of the keyword.

2. The device of claim 1, further comprising:
a raster plot generator to generate the raster plot of the events.

3. The device of claim 1, wherein the keyword detector comprises a neural network.

4. The device of claim 1, wherein the event generator comprises:
an integrator to integrate the audio signal;
a comparator to compare values of an integrated audio signal to a threshold, wherein an event is generated for each value of the integrated audio signal that exceeds the threshold; and
a reset timer to pause the integrator for a predefined time after the event is generated.

5. The device of claim 4, wherein the threshold comprises a positive threshold and a negative threshold.

6. The device of claim 2, wherein the event generator comprises a plurality of event generators, wherein the raster plot generated by the raster plot generator includes each event generated by each one of the plurality of event generators.

7. The device of claim 6, wherein the plurality of event generators are set with different thresholds.

8. The device of claim 6, further comprising a feedback loop, wherein the feedback loop is to adjust at least one of: a threshold value of the plurality of event generators or an enable setting of the plurality of event generators based on a confidence score from a confidence calculator and an accuracy score from the digital signal processor from a sampled version of the audio signal.

9. A method, comprising:
receiving an audio signal;
generating, by an event based keyword detector, a plurality of events form the audio signal;
generating, by the event based keyword detector, a raster plot of the plurality of events;
analyzing, by the event based keyword detector, the raster plot to detect a pattern in the plurality of events that is associated with a keyword; and
activating a digital signal processor to analyze subsequent audio streams in response to the keyword being detected.

10. The method of claim 9, wherein the generating the plurality of events, comprises:
integrating the audio signal over time;
comparing a value of an integrated audio signal at a particular time to a threshold; and
generating an event when the value of the integrated audio signal exceeds the threshold.

11. The method of 10, further comprising:
pausing for a predefined period of time after the event is generated before continuing to integrate the audio signal over time.

12. The method of claim 9, further comprising:
tuning the event based keyword detector to detect the keyword with an amount of accuracy and an amount of confidence above a desired threshold before the audio signal is received.

13. The method of claim 12, wherein the tuning, comprises:
storing the audio signal in memory;
comparing detection of the keyword by the event based keyword detector to detection of the keyword by the digital signal processor in the audio signal stored in the memory;
adjusting a threshold value of at least one of a plurality of event generators of the event based keyword detector or disabling at least one of the plurality of event generators of the event based keyword detector; and
repeating the storing, the comparing, and the adjusting until the amount of accuracy and the amount of confidence is above the desired threshold.

14. A non-transitory computer readable storage medium encoded with instructions executable by a processor, the non-transitory computer-readable storage medium comprising:
instructions to set a threshold value for a plurality of event generators of an event based keyword detector;
instructions to receive an audio signal;
instructions to detect a keyword from the audio signal by the event based keyword detector based on a pattern of events generated by each one of the plurality of event generators and recorded in a raster plot, wherein an event is generated when an integrated audio signal value exceeds the threshold; and
instructions to activate a digital signal processor to analyze subsequent audio streams after the keyword is detected by the event based keyword detector.

15. The non-transitory computer readable storage medium of claim 14, wherein increasing the threshold value decreases an amount of events generated by an event generator of the plurality of event generators and decreasing the threshold value increases the amount of events generated by the event generator.
